(19) United States
(12) Patent Application Publication
(10) Pub. No.: US 2015/0349626 A1
(43) Pub. Date: Dec. 3, 2015

(54) OUTPUT FILTER FOR PARALLELED INVERTER

(71) Applicant: Hamilton Sundstrand Corporation, Windsor Locks, CT (US)

(72) Inventors: Dong Jiang, Manchester, CT (US); Miaosen Shen, Vernon, CT (US)

(73) Assignee: Hamilton Sundstrand Corporation, Windsor Locks, CT (US)

(21) Appl. No.: 14/291,908

(22) Filed: May 30, 2014

(51) Int. Cl. H02M 1/44; H02M 7/44

(52) U.S. Cl. CPC H02M 1/44; H02M 7/44

(57) ABSTRACT

A power conversion system includes a paralleled inverter and a plurality of coupling inductors. The paralleled inverter is configured to convert a direct current input into an alternating current output and includes a first inverter having a first plurality of phase outputs and a second inverter having a second plurality of phase outputs, which may achieve negligible common-mode output voltage. The plurality of coupling inductors connect one of the first plurality of phase outputs with one of the second phase outputs to filter differential-mode electromagnetic interference and circulation current.

### BACKGROUND

The present invention relates generally to power inverters, and in particular to a system and method for controlling paralleled inverters using pulse-width modulation (PWM).

Three-phase inverters are often implemented within, for example, variable speed motor drives. Three-phase inverters are utilized, for example, to convert a direct current (DC) input into an alternating current (AC) output for a motor or other load that utilizes AC power. Prior art inverters were implemented as single stage inverters having a plurality of switches. The switches are selectively enabled and disabled to convert the DC input power into controlled AC output power.

Electromagnetic interference, or “noise,” is a common problem in electrical circuit design. Noise may originate from natural sources, such as background radiation or lightning strikes, but the more common and more problematic noise is electromagnetic noise generated by components in electrical systems, such as three-phase inverters. EMI noise can be divided into two major groups: differential-mode (DM) EMI and common-mode (CM) EMI. CM noise creates several concerns such as conduction through bearings in the motor which may reduce the reliability of the motor. In prior art systems, CM filters containing, for example, CM chokes and CM capacitors are utilized to filter the CM noise. The weight of CM filters is dependent upon the CM voltage of the inverter. Different PWM schemes for inverter control can generate different CM voltage, but CM voltage cannot be eliminated for prior art two-level inverters. It is desirable to eliminate the CM output voltage of the inverter to eliminate the need for CM filters.

### SUMMARY

A power conversion system includes a paralleled inverter and a plurality of coupling inductors. The paralleled inverter is configured to convert a direct current input into an alternating current output and includes a first inverter having a first plurality of phase outputs and a second inverter having a second plurality of phase outputs. The plurality of coupling inductors connect one of the first plurality of phase outputs with one of the second phase outputs to filter differential-mode electromagnetic interference and circulation current.

### BRIEF DESCRIPTION OF THE DRAWINGS

FIG. 1 is a circuit diagram illustrating a paralleled inverter that includes two inverters.

FIGS. 2A and 2B are vector diagrams illustrating control vectors for a paralleled invertor.

FIG. 3 is a chart illustrating gate pulse generation for a switching cycle of a paralleled inverter.

FIG. 4 is a block diagram illustrating a pulse-width modulation control system for a paralleled inverter.

FIG. 5 is a schematic diagram illustrating a coupling inductor for use in an output of a paralleled invertor.

### DETAILED DESCRIPTION

A power conversion system is disclosed herein that includes parallel inverters for producing zero common-mode (CM) voltage output. A controller controls the paralleled inverter using six unit vectors. Each unit vector, when utilized to control the paralleled inverter, provides negligible CM voltage at the paralleled inverter output. Because of this, no CM filter is required, reducing the overall weight and cost of the power conversion system. An output filter that includes coupling inductors is configured to filter differential-mode (DM) electromagnetic interference (EMI). The coupling inductors both constrain the circulation current from the paralleled inverter as well as filter the DM voltage.

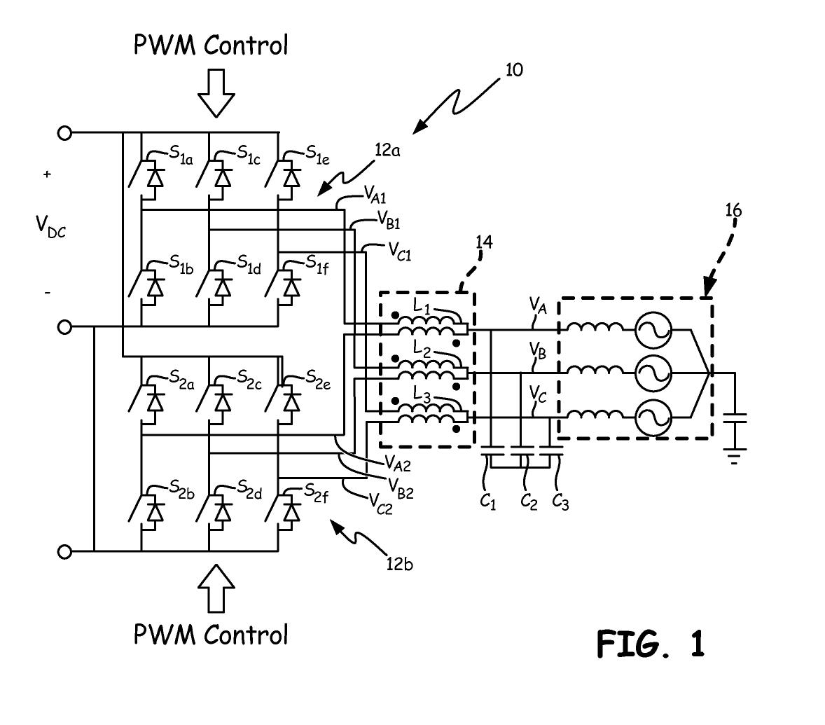

FIG. 1 is a circuit diagram illustrating paralleled inverter 10 that includes inverters 12a and 12b. Inverter 12a includes switches S₁ₐ-S_{1f} and inverter 12b includes switches S₂ₐ-S_{2f}. The three phase outputs from inverters 12a and 12b are provided to coupling inductors 14 that include inductors L₁-L₃. Capacitors C₁-C₃ are connected between each phase output from coupling inductors 14 and a common point. The three phase outputs from coupling inductors 14 are provided to, for example, three-phase motor 16. Although illustrated as providing power to three-phase motor 16, paralleled inverter 10 may be utilized in any power conversion system to provide power for any AC load.

Inverters 12a and 12b are configured in a parallel configuration and both receive input from the V_{DC} bus. The V_{DC} bus provides direct current (DC) power to parallel inverter 10 from any DC source such as, for example, an active rectifier. Inverters 12a and 12b may both be configured as two level inverters. For example, with reference to a mid-point of the DC bus, for output V_{A1}, switch S₁ₐ may be enabled to provide +V_{DC}/2 to output V_{A1} (positive DC bus voltage) and switch S_{1b} may be enabled to provide −V_{DC}/2 to output V_{A1} (negative DC bus voltage). For output V_{A2}, switch S₂ₐ may be enabled to provide +V_{DC}/2 to output V_{A2}, and switch S_{2b} may be enabled to provide −V_{DC}/2 to output V_{A2}. V_{A1} and V_{A2} are both provided to coupling inductor L₁, which provides a single output V_{A} to three-phase motor 16, constrains circulation current, and filters DM noise. Circulation currents are currents that flow from inverter 12a into inverter 12b or vice versa, for example, a circulating current may flow from output V_{A1} into output V_{A2}. The same operation is performed for the other outputs V_{B} and V_{C}. The three outputs V_{A}, V_{B}, and V_{C} are provided to motor 16.

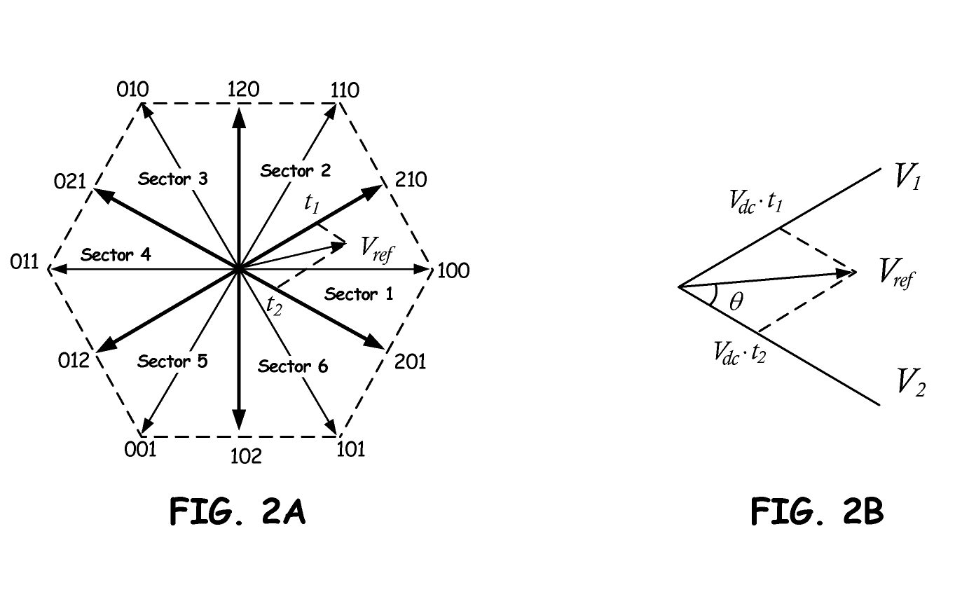

With continued reference to FIG. 1, FIGS. 2A and 2B are vector diagrams illustrating control vectors for paralleled invertor 10. In space vector pulse-width modulation (SVPWM) control, a two-dimensional control vector is utilized to control the output voltage of paralleled inverter 10. The control vector (V_{ref}) is generated based upon the desired three-phase output (V_{A}, V_{B} and V_{C}) of paralleled inverter 10. V_{ref} may be generated using any desired method, such as converting a desired three-phase output (V_{A}, V_{B}, and V_{C}) into a two-dimensional DQ or αβ reference frame using a Park and/or Clarke transformation. The resultant V_{ref} control vector will fall into one of the six sectors shown in FIG. 2A. The transformation will also provide the angle θ of the position of V_{ref}.

In single two-stage inverters, the six unit vectors (0,0,1; 0,1,0; 0,1,1; 1,0,0; 1,0,1; and 1,1,0) as shown in FIG. 2A are utilized to control the inverter. For example, if the 0,1,0 unit vector is applied to inverter 12a, switches S_{1b}, S_{1c}, and S_{1f} would be enabled to provide −V_{DC}/2 to the V_{A1} output, V_{DC}/2 to the V_{B1} output, and −V_{DC}/2 to the V_{C1} output. Each of inverters 12a and 12b may be controlled utilizing these six single two-stage inverter unit vectors.

For paralleled inverter 10, six new unit vectors (1,0,2; 2,0,1; 2,1,0; 1,2,0; 0,2,1; and 0,1,2), as shown in FIG. 2A, may be utilized as combinations of adjacent single inverter unit vectors. For example, paralleled inverter unit vector 1,0,2 is formed through combination of single inverter unit vectors 0,0,1 and 1,0,1, and paralleled inverter unit vector 2,0,1 is formed through combination of single inverter unit vectors 1,0,1 and 1,0,0. For unit vector 2,0,1, for example, inverter 12a may be controlled using single inverter unit vector 1,0,1, and inverter 12b may be controlled using single inverter unit vector 1,0,0. Additionally, inverter 12a may be controlled using single inverter unit vector 1,0,0, and inverter 12b may be controlled using single inverter unit vector 1,0,1.

When controlled using the six new unit vectors (1,0,2; 2,0,1; 2,1,0; 1,2,0; 0,2,1; and 0,1,2), parallel inverter 10 produces zero or negligible CM voltage on outputs V_{A}-V_{C}. This negligible CM voltage may be, for example, less than one percent of V_{DC}. The following equation is used to calculate the CM voltage produced on outputs V_{A}-V_{C}:

V_{CM}=(⅓)(V_{A}+V_{B}+V_{C})=(⅙)(V_{A1}+V_{A2}+V_{B1}+V_{B2}+V_{C1}+V_{C2}) (1)

As seen in equation (1), with a single stage inverter, where each phase produces an output of either +V_{DC}/2 or −V_{AC}/2, there will be a nonzero CM voltage output due to the odd number of outputs. With parallel inverter 10 that includes six outputs, it is possible to eliminate the CM output due to the even number of outputs. The six new unit vectors always provide an output such that V_{CM} is equal to zero. For example, if paralleled inverter 10 is controlled using unit vector 1,0,2, inverter 12a may be controlled with single inverter unit vector 0,0,1, and inverter 12b may be controlled with single inverter unit vector 1,0,1. In this case, switches S_{1b}, S_{1d}, S₁ₑ, S₂ₐ, S_{2d}, and S₂ₑ would be enabled providing zero volts on V_{A}, −V_{DC} on V_{B}, and +V_{DC} on V_{C}, which provides zero CM voltage between V_{A}, V_{B}, and V_{C}.

FIG. 2B illustrates a sample control vector V_{ref} that is utilized to control inverters 12a and 12b to obtain a desired output (V_{A}, V_{B}, and V_{C}). In SVPWM control, a control vector is produced based upon a desired three-phase output (V_{A}, V_{B}, and V_{C}). The control vector may be generated using any method, such as a Park and/or Clarke transformation. The control vector will fall somewhere within the vector diagram shown in FIG. 2A. In FIGS. 2A and 2B, a sample control vector V_{ref} is shown in Sector 1. For the sample control vector V_{ref} shown in FIG. 2A, vector V₁ of FIG. 2B corresponds to new unit vector 2,1,0, and vector V₂ of FIG. 2B corresponds to new vector 2,0,1. The angle θ is the angle between new unit vector V₂ and control vector V_{ref}.

As shown in FIG. 2A, control vector V_{ref} may be obtained by operating parallel inverter 10 utilizing unit vector 2,1,0 for a first time period t₁, and operating parallel inverter 10 utilizing unit vector 2,0,1 for a second time period t₂. Because t₁ and t₂ may not equal an entire switching period T_{S}, another time period, t₀, is determined for which the outputs V_{A}, V_{B}, and V_{C} will all be zero. This is achieved by utilizing zero unit vectors 1,1,1 and 0,0,0, or vice versa, to control inverters 12a and 12b, respectively. The following equations may be utilized to determine values for t₀, t₁, and t₂ based upon the positive DC rail voltage +V_{DC}, the angle θ, and the magnitude of the control vector V_{ref}.

$$\{ \begin{matrix}\frac{{V}_{dc} \cdot {t}_{1}}{sin θ} = \frac{{V}_{dc} \cdot {t}_{2}}{sin ( \frac{π}{3} - θ )} = \frac{{V}_{ref} \cdot {T}_{s}}{sin ( \frac{2 π}{3} )} \\ {t}_{0} = {T}_{s} - {t}_{1} - {t}_{2}\end{matrix} \qquad ( 2 )$$

Following determination of t₀, t₁, and t₂, inverters 12a and 12b may be controlled to provide the desired output indicated by control vector V_{ref}. The switching period T_{S} may be split into two half cycles. Each half cycle may include half of each of t₀, t₁ and t₂. For example, the progression for each cycle may be t₀/4, t₁/2, t₂/2, t₀/2, t₁/2, t₂/2, and t₀/4. For example, if paralleled inverter 10 is controlled using unit vector 1,2,0 for period t₁, then inverter 12a may be controlled with single inverter unit vector 0,1,0 and inverter 12b may be controlled with single inverter unit vector 1,1,0 for the first half of period t₁. For the second half of period t₁, inverter 12a may be controlled with single inverter unit vector 1,1,0 and inverter 12b may be controlled with single inverter unit vector 0,1,0. This provides balance for each switching cycle T_{S}, which balances the circulating current through paralleled inverter 10 which may then be easily limited by coupling inductors 14.

Based upon the sector in which V_{ref} is located, the following tables may be utilized to determine the desired control of inverters 12a and 12b for a given switching cycle T_{S}.

TABLE 1

| Sector One | Inverter 12a | Inverter 12b |
|---|---|---|
| t₀/4 | 1, 1, 1 | 0, 0, 0 |
| t₁/2 | 1, 1, 0 | 1, 0, 0 |
| t₂/2 | 1, 0, 0 | 1, 0, 1 |
| t₀/2 | 0, 0, 0 | 1, 1, 1 |
| t₁/2 | 1, 0, 0 | 1, 1, 0 |
| t₂/2 | 1, 0, 1 | 1, 0, 0 |
| t₀/4 | 1, 1, 1 | 0, 0, 0 |

TABLE 2

| Sector Two | Inverter 12a | Inverter 12b |
|---|---|---|
| t₀/4 | 1, 1, 1 | 0, 0, 0 |
| t₁/2 | 1, 1, 0 | 0, 1, 0 |
| t₂/2 | 1, 0, 0 | 1, 1, 0 |
| t₀/2 | 0, 0, 0 | 1, 1, 1 |
| t₁/2 | 0, 1, 0 | 1, 1, 0 |
| t₂/2 | 1, 1, 0 | 1, 0, 0 |
| t₀/4 | 1, 1, 1 | 0, 0, 0 |

TABLE 3

| Sector Three | Inverter 12a | Inverter 12b |
|---|---|---|
| t₀/4 | 1, 1, 1 | 0, 0, 0 |
| t₁/2 | 0, 1, 1 | 0, 1, 0 |
| t₂/2 | 0, 1, 0 | 1, 1, 0 |
| t₀/2 | 0, 0, 0 | 1, 1, 1 |
| t₁/2 | 0, 1, 0 | 0, 1, 1 |
| t₂/2 | 1, 1, 0 | 0, 1, 0 |
| t₀/4 | 1, 1, 1 | 0, 0, 0 |

TABLE 4

| Sector Four | Inverter 12a | Inverter 12b |
|---|---|---|
| t₀/4 | 1, 1, 1 | 0, 0, 0 |
| t₁/2 | 0, 1, 1 | 0, 0, 1 |
| t₂/2 | 0, 1, 0 | 0, 1, 1 |
| t₀/2 | 0, 0, 0 | 1, 1, 1 |
| t₁/2 | 0, 0, 1 | 0, 1, 1 |
| t₂/2 | 0, 1, 1 | 0, 1, 0 |
| t₀/4 | 1, 1, 1 | 0, 0, 0 |

TABLE 5

| Sector Five | Inverter 12a | Inverter 12b |
|---|---|---|
| t₀/4 | 1, 1, 1 | 0, 0, 0 |
| t₁/2 | 1, 0, 1 | 0, 0, 1 |
| t₂/2 | 0, 0, 1 | 0, 1, 1 |
| t₀/2 | 0, 0, 0 | 1, 1, 1 |
| t₁/2 | 0, 0, 1 | 1, 0, 1 |
| t₂/2 | 0, 1, 1 | 0, 0, 1 |
| t₀/4 | 1, 1, 1 | 0, 0, 0 |

TABLE 6

| Sector Six | Inverter 12a | Inverter 12b |
|---|---|---|
| t₀/4 | 1, 1, 1 | 0, 0, 0 |
| t₁/2 | 1, 0, 1 | 1, 0, 0 |
| t₂/2 | 0, 0, 1 | 1, 0, 1 |
| t₀/2 | 0, 0, 0 | 1, 1, 1 |
| t₁/2 | 1, 0, 0 | 1, 0, 1 |
| t₂/2 | 1, 0, 1 | 0, 0, 1 |
| t₀/4 | 1, 1, 1 | 0, 0, 0 |

As shown in Tables 1-6, each phase of each inverter 12a and 12b only changes state twice each switching cycle (i.e. from a ‘0’ to a ‘1’ or from a ‘1’ to a ‘0’). In past SVPWM controlled two-level inverters, the sequence progressed t₀/4, t₁/2, t₂/2, t₀/2, t₂/2, t₁/2, and t₀/4 for symmetry in each half of the switching cycle (T_{S}/2). With paralleled inverter 10 producing no CM output voltage, each half of the switching cycle does not need to be symmetric, and the sequence may progress as shown in Tables 1-6 to achieve minimum switching events for each phase of paralleled inverter 10.

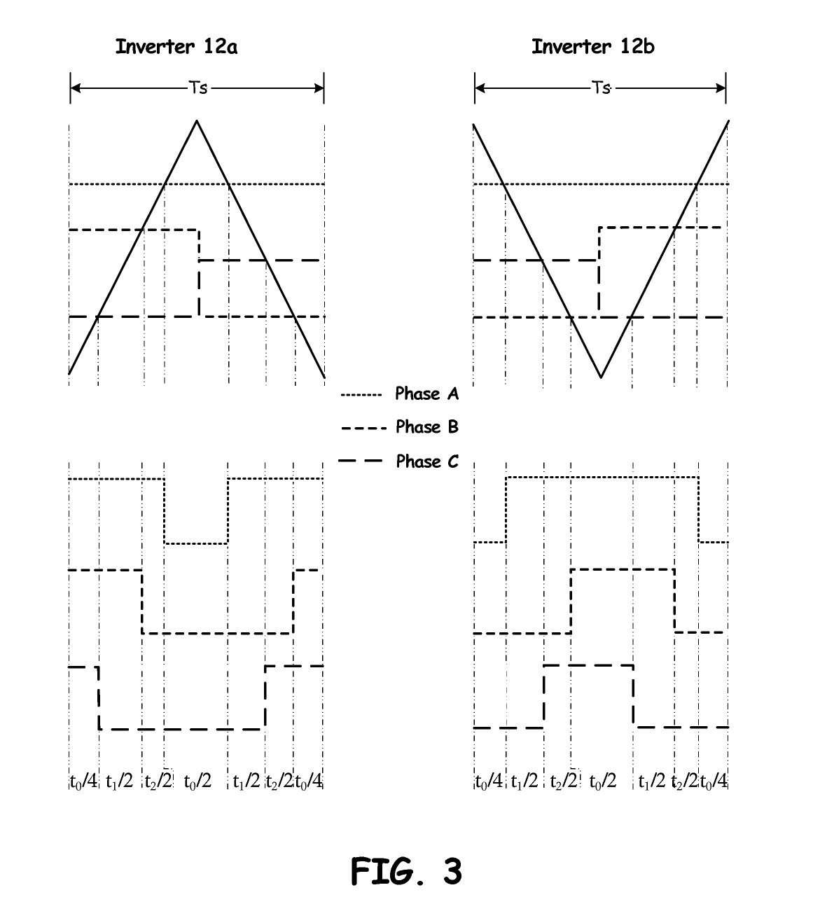

With continued reference to FIG. 1 and FIGS. 2A and 2B, FIG. 3 a chart illustrating control waveforms in a switching cycle (T_{S}) for a paralleled inverter that produces a zero CM voltage output in sector 1 (Table 1). The top waveform illustrates comparator waveforms and a triangle-wave carrier signal. The waveforms shown in FIG. 3 are for a control vector V_{ref} in sector one as illustrated in FIG. 2A. Because the two half cycles of T_{S} are not symmetrical, some of the comparator signals include a step up or down at the half cycle. The comparator signals may be utilized to generate the control signals for each of inverters 12a and 12b. The comparator signals shown in FIG. 3 are compared to the triangle-wave carrier signal to generate a control signal for each phase. The control signals are illustrated in the bottom waveform of FIG. 3 and correspond to the values shown in Table 1. For control vectors that fall in the other sectors, comparator signals will be generated that will be utilized to generate the control signals indicated in a respective Table 2-6.

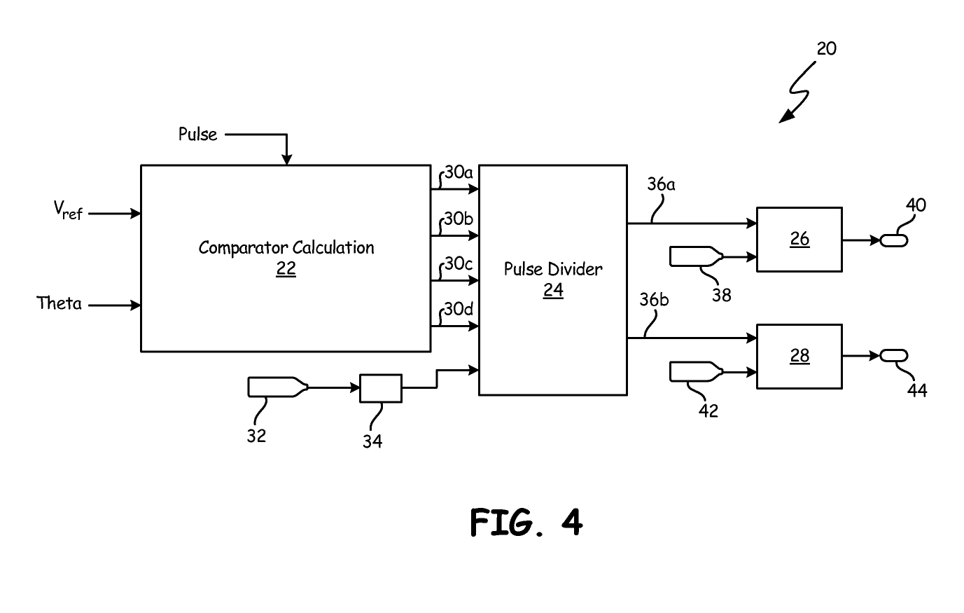

With continued reference to FIGS. 1-3, FIG. 4 is a block diagram illustrating a controller 20 for paralleled inverter 10. Control system 20 includes comparator calculator 22, pulse divider 24, and PWM calculators 26 and 28. Comparator calculator 22 provides outputs 30a-30d to pulse divider 24. Pulse divider 24 receives input from triangle-wave carrier input 32 through derivative module 34. Pulse divider 24 provides output 36a to PWM calculator 26 and provides output 36b to PWM calculator 28. PWM calculator 26 receives input from triangle-wave carrier input 38 and provides PWM output 40. PWM calculator 28 receives input from triangle-wave carrier input 42 and provides PWM output 44. Control system 20 may be implemented as any electronic system capable of providing control signals for inverters 12a and 12b. Control system 20 may be, for example, implemented in software and run on a microprocessor, may be implemented as discrete electronic components, or as any other electronic system.

Comparator 22 receives a control vector V_{ref} and angle θ from, for example, a separate controller, or the same controller that implements control system 20. Comparator 22 determines values for t₀, t₁ and t₂ using, for example, equation (2). Following determination of t₀, t₁, and t₂, based upon the sector in which V_{ref} falls, comparator 22 produces the comparator signals illustrated in FIG. 3, based upon the respective tables 1-6. Comparator 22 generates a first set of comparator values 30a for inverter 12a, a second set of comparator values 30b for inverter 12a, a first set of comparator values 30c for inverter 12b, and a second set of comparator values 30d for inverter 12b. The first set for each of inverters 12a and 12b are comparator values for a first half cycle of a switching period T_{S}, and the second set for each of inverters 12a and 12b are comparator values for a second half cycle of the switching period T_{S}.

Pulse divider 24 receives the four sets of comparator values 30a-30d and also receives an input from derivative module 34. The input is indicative of a change in triangle carrier wave input 32. In this way, pulse divider 24 is able to determine the present half cycle of T_{S}. Based upon the present half cycle of TS, pulse divider 24 provides the respective comparator signals to PWM calculators 26 and 28. PWM calculator 26 compares the comparator signals with a triangle-wave carrier input signal from input 38 and PWM calculator 28 compares the comparator signals with a triangle-wave carrier input signal from input 42. This comparison is illustrated in FIG. 3. PWM calculator 26 provides control signals (shown in FIG. 3) for inverter 12a on PWM output 40 based upon the comparison, and PWM calculator 28 provides control signals (shown in FIG. 3) for inverter 12b on PWM output 44 based upon the comparison. PWM calculators 26 and 28 may be implemented as any circuit capable of comparing two values and may be implemented as electronic comparators, or in software.

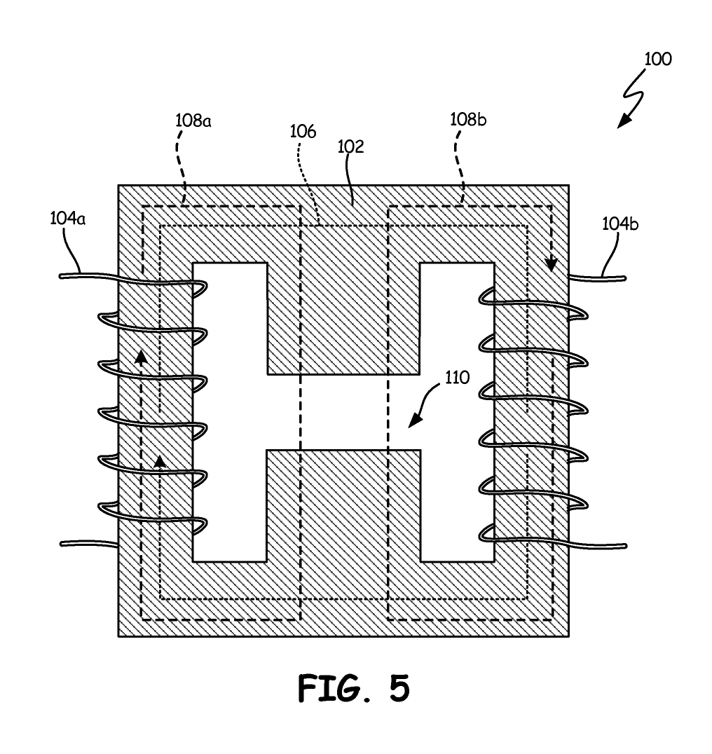

With continued reference to FIGS. 1-4, FIG. 5 is a schematic diagram illustrating coupling inductor 100 for use in coupling inductors 14 (FIG. 1) at the output of paralleled invertor 10 (FIG. 1). Inductor 100 includes core 102 and windings 104a and 104b. Coupling inductor flux path 106 and leakage inductor flux paths 108a and 108b. As illustrated in FIG. 5, core 102 may be two ‘E’ cores with an air gap 110 in the central leg.

Windings 104a and 104b are wound around opposing legs, in inversed directions. For example, a positive current through winding 104a will flow in the opposite direction of a positive current in winding 104b. Winding 104a may be connected to one of the phase outputs (V_{A1}, V_{B1}, V_{C1}) of inverter 12a, and winding 104b may be connected to one of the phase outputs (V_{A2}, V_{B2}, V_{C2}) of inverter 12b. The outputs of windings 104a and 104b may be connected to form primary outputs (V_{A}, V_{B}, V_{C}) provided to motor 16.

Flux path 106 shows the coupling inductor flux, which flows through the path that does not include air gap 110. Flux paths 108a and 108b illustrate the leakage inductor flux, which flows through air gap 110. Coupling inductor flux 106 is generated by the circulating current between inverters 12a and 12b, and is utilized to limit this circulating current. Leakage inductor flux 108a and 108b is generated by the output current from inverters 12a and 12b, and this inductance is used to filter DM noise. Using coupling inductor 100, the density of coupling inductors L₁-L₃ (FIG. 1) can be high and can perform as both a DM filter as well as a circulating current control.

By utilizing paralleled inverter 10 with coupling inductors 14 and capacitors C₁-C₃, a power conversion system may be implemented that produces negligible CM voltage. Because of this, prior art CM chokes and CM capacitors may be eliminated from the circuit, which greatly improves the power density of the system. By eliminating CM output of paralleled inverter 10, the CM current received by motor 16 is greatly reduced, which protects the insulation and bearings of motor 16, and may increase the life span and reliability of motor 16. Eliminating the CM voltage may also limit output current ripple, odd harmonics of the switching frequency, and DC capacitor ripple currents. Paralleled inverter 10 also provides fault-tolerant control in that the system may still function upon failure of one of inverters 12a or 12b.

Discussion of Possible Embodiments

The following are non-exclusive descriptions of possible embodiments of the present invention.

A power conversion system includes a paralleled inverter and a plurality of coupling inductors. The paralleled inverter is configured to convert a direct current input into an alternating current output and includes a first inverter having a first plurality of phase outputs and a second inverter having a second plurality of phase outputs. The plurality of coupling inductors connect one of the first plurality of phase outputs with one of the second phase outputs to filter differential-mode electromagnetic interference and circulation current.

A further embodiment of the foregoing system, wherein the plurality of coupling inductors includes a first coupling inductor connected to a first output of the first plurality of phase outputs and a first output of the second phase outputs, the first coupling inductor providing a first primary output, a second coupling inductor connected to a second output of the first plurality of phase outputs and a second output of the second phase outputs, the second coupling inductor providing a second primary output, and a third coupling inductor connected to a third output of the first plurality of phase outputs and a third output of the second phase outputs, the third coupling inductor providing a third primary output.

A further embodiment of any of the foregoing systems, further including a first capacitor connected between the first primary output and a midpoint, a second capacitor connected between the second primary output and the midpoint, and a third capacitor connected between the third primary output and the midpoint, wherein the first capacitor, the second capacitor, and the third capacitor filter differential-mode noise on the first primary output, the second primary output, and the third primary output.

A further embodiment of any of the foregoing systems, wherein the alternating current output is provided to an alternating current load.

A further embodiment of any of the foregoing systems, wherein each of the plurality of coupling inductors includes a core having a first leg, an opposing second leg, and a central air gap, a first coil wound around the first leg that receives a first current, and a second coil wound around the second leg that receives a second current, wherein a flux direction generated by the second current is received in an opposite direction of a flux direction generated by the first current.

A further embodiment of any of the foregoing systems, wherein the core of each of the plurality of coupling inductors comprises a pair of ‘E’ cores.

A further embodiment of any of the foregoing systems, wherein each of the plurality of coupling inductors utilizes a coupling inductor flux generated in the core by the first and second currents to limit a circulation current in the paralleled inverter.

A further embodiment of any of the foregoing systems, wherein each of the plurality of coupling inductors utilizes a leakage inductor flux generated in the core by the first and second currents to filter differential-mode noise in the paralleled inverter.

A further embodiment of any of the foregoing systems, wherein the first current is received from one of the first plurality of phase outputs and the second current is received from one of the second plurality of phase outputs.

A further embodiment of any of the foregoing systems, further comprising a controller that controls the paralleled converter to produce negligible common-mode voltage.

A method of filtering differential-mode noise from a paralleled inverter, the method including providing a first plurality of outputs from a first inverter of the paralleled inverter to a plurality of coupling inductors, providing a second plurality of outputs from a second inverter of the paralleled inverter to the plurality of coupling inductors, and filtering, using the plurality of coupling inductors, the differential-mode noise from the paralleled inverter.

A further embodiment of the foregoing method, further including controlling, using a controller, the paralleled inverter to generate negligible common-mode voltage.

A further embodiment of any of the foregoing methods, further including providing power on a plurality of primary outputs from the plurality of coupling inductors to drive an alternating current load.

A further embodiment of any of the foregoing methods, further including filtering, using a capacitor circuit, the differential-mode noise on the plurality of primary outputs.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A power conversion system comprising:
a paralleled inverter configured to convert a direct current input into an alternating current output, wherein the paralleled inverter includes a first inverter having a first plurality of phase outputs and a second inverter having a second plurality of phase outputs; and
a plurality of coupling inductors, wherein each of the plurality of coupling inductors connects one of the first plurality of phase outputs with one of the second phase outputs to filter differential-mode electromagnetic interference and circulation current.

2. The power conversion system of claim 1, wherein the plurality of coupling inductors comprises:
a first coupling inductor connected to a first output of the first plurality of phase outputs and a first output of the second phase outputs, the first coupling inductor providing a first primary output;
a second coupling inductor connected to a second output of the first plurality of phase outputs and a second output of the second phase outputs, the second coupling inductor providing a second primary output; and
a third coupling inductor connected to a third output of the first plurality of phase outputs and a third output of the second phase outputs, the third coupling inductor providing a third primary output.

3. The power conversion system of claim 2, further comprising:
a first capacitor connected between the first primary output and a midpoint;
a second capacitor connected between the second primary output and the midpoint; and
a third capacitor connected between the third primary output and the midpoint, wherein the first capacitor, the second capacitor, and the third capacitor filter differential-mode noise on the first primary output, the second primary output, and the third primary output.

4. The power conversion system of claim 2, wherein the alternating current output is provided to an alternating current load.

5. The power conversion system of claim 1, wherein each of the plurality of coupling inductors comprises:
a core having a first leg, an opposing second leg, and a central air gap;
a first coil wound around the first leg that receives a first current; and
a second coil wound around the second leg that receives a second current, wherein a flux direction generated by the second current is received in an opposite direction of a flux direction generated by the first current.

6. The power conversion system of claim 5, wherein the core of each of the plurality of coupling inductors comprises a pair of ‘E’ cores.

7. The power conversion system of claim 5, wherein each of the plurality of coupling inductors utilizes a coupling inductor flux generated in the core by the first and second currents to limit a circulation current in the paralleled inverter.

8. The power conversion system of claim 5, wherein each of the plurality of coupling inductors utilizes a leakage inductor flux generated in the core by the first and second currents to filter differential-mode noise in the paralleled inverter.

9. The power conversion system of claim 5, wherein the first current is received from one of the first plurality of phase outputs and the second current is received from one of the second plurality of phase outputs.

10. The power conversion system of claim 1, further comprising a controller that controls the paralleled converter to produce negligible common-mode voltage.

11. A method of filtering differential-mode noise from a paralleled inverter, the method comprising:
providing a first plurality of outputs from a first inverter of the paralleled inverter to a plurality of coupling inductors;
providing a second plurality of outputs from a second inverter of the paralleled inverter to the plurality of coupling inductors; and
filtering, using the plurality of coupling inductors, the differential-mode noise from the paralleled inverter.

12. The method of claim 11, further comprising controlling, using a controller, the paralleled inverter to generate negligible common-mode voltage.

13. The method of claim 11, further comprising providing power on a plurality of primary outputs from the plurality of coupling inductors to drive an alternating current load.

14. The method of claim 13, further comprising filtering, using a capacitor circuit, the differential-mode noise on the plurality of primary outputs.
